(19) United States
(12) Patent Application Publication
(10) Pub. No.: US 2007/0223491 A1
(43) Pub. Date: Sep. 27, 2007

(54) Apparatus and method for providing quality of service in wireless communication system

(75) Inventors: Hye-Won Baek, Suwon-si (KR); Jae-Woo Kwon, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/726,180

(22) Filed: Mar. 20, 2007

(30) Foreign Application Priority Data
Mar. 20, 2006 (KR) 2006-0025170

(51) Int. Cl. H04L 12/56; H04J 3/16

(52) U.S. Cl. 370/395.21; 370/469

(57) ABSTRACT

Provided are an apparatus and a method for providing a quality of service (QoS) in a wireless communication system. The method includes transmitting an enable media message that includes QoS information of the application layers from an Internet Protocol (IP) Multimedia Subsystem (IMS) server to a policy server, transforming and mapping the QoS information of the application layer into QoS information of an IP layer in the policy server and transmitting a common open policy service decision (COPS-DEC) message that includes the QoS information of the IP layer from the policy server to a base station (BS), and transforming and mapping the QoS information of the IP layer into QoS information of a media access control (MAC) layer in the BS and transmitting a dynamic service addition request (DSA-REQ) message that includes the QoS information of the MAC layer from the BS to the transmitter terminal.

### PRIORITY

This application claims priority under 35 U.S.C. §119 to an application filed in the Korean Intellectual Property Office on Mar. 20, 2006 and assigned Serial No. 2006-25170, the contents of which are incorporated herein by reference.

### BACKGROUND OF THE INVENTION

1. Field of the Invention

The present invention relates generally to a wireless communication system, and in particular, to an apparatus and a method for providing a quality of service (QoS) to minimize a load applied to a terminal.

2. Description of the Related Art

A current wireless communication network supports a quality of service (QoS) to provide a streaming service including the Best Effort Internet services, Voice over Internet Protocols (VoIPs), and broadcasts. The QoS refers to a network service standard which must be satisfied to provide sufficient service levels to users when voice and/or video data, such as moving pictures, is transmitted. The QoS can relate to network technology by which service levels are differentiated according to the priority of users or applications to manage traffic and bandwidth within a limited bandwidth.

Extensive research is being conducted to secure a QoS in a conventional wire and/or wireless communication system. For example, 3^{rd} Generation Partnership Project (3GPP) and 3GPP2 standardization groups suggest standards which must be satisfied to provide an Internet Protocol (IP) Multimedia Subsystem (IMS)-based End-to-End QoS which integrates Internet and wireless mobile communication environments.

FIGS. 1A and 1B illustrate a process of generating a VoIP call in a wireless communication system according to the prior art.

Referring to FIGS. 1A and 1B, in step 110 a first terminal 100 transmits to an IMS server 106 a session initiation protocol (SIP) invite message including session description protocol (SDP) information, in order to generate a VoIP session. In step 112 the IMS server 106 transmits the SIP invite message to a second terminal 108. In step 114 the IMS server 106 receives from the second terminal 108 an SIP 183 message including its SDP information. In step 116 the IMS server 106 transmits to a policy server 104 an authority request message including the SDP information of the first and second terminals 100 and 108. In step 118 the IMS server 106 receives from the policy server 104 an authority response message including an authentication token. In step 120 the IMS server 106 transmits to the first terminal 100 the SIP 183 message including the authentication token.

In step 122 the first terminal 100 transforms and maps the SDP information as QoS information of an application layer into QoS information of a media access control (MAC) layer, in order to request an allocation of dynamic resources of a base station (BS) 102. In step 124 the first terminal 100 transmits the BS 102 a dynamic service addition request (DSA-REQ) message including the QoS information of the MAC layer to. In step 126 the BS 102 transmits to the policy server 104 a common open policy service request (COPS-REQ) message including binding information (SIP signaling information, bearer information combination identifiers, and the authentication token). In step 128 the policy server 104 transmits to the IMS server 106 the authority request message. In step 130 the policy server 104 receives the authority response message from the IMS server 106 to transform and map the SDP information into IP QoS information. In step 134 the policy server 104 transmits to the BS 102 COPS decision (COPS-DEC) message including the IP QoS information.

In step 136 the BS 102 transmits a COPS report (COPS-RPT) message to the policy server 104, transforms and maps the IP QoS information into MAC QoS information, and performs a QoS negotiation. The BS 102 transmits a DSA response (DSA-RSP) message to the first terminal 100 in step 140. In step 142 the first terminal 100 transmits to the BS 102 a DSA acknowledge (DSA-ACK) message to the DSA-RSP message.

In step 144 the second terminal 108 transmits to the IMS server 106 a SIP 200 message indicating a participation in a session. In step 146 the IMS server 106 transmits an enable media message to the policy server 104 to request enabling of bearer resources of a corresponding session. In step 148 the policy server 104 transmits the COPS-DEC message to the BS 102 to enable allocated bearer resources. In step 150 the BS 102 transmits the COPS-RPT message to the policy server 104. In step 152 the policy server 104 transmits an acknowledge message to the enable media message to the IMS server 106. In step 154 the IMS server 106 transmits the SIP 200 message to the first terminal 100. In steps 156 and 158 the first terminal 100 transmits a SIP acknowledge (SIP ACK) message to the second terminal 108 through the IMS server 106 to end the process of generating the VoIP call.

In a conventional wireless communication system as described above, a terminal transforms and maps QoS information of an upper application layer into QoS information of a lower MAC layer as in step 122 above in order to provide an efficient QoS. Whenever an application program is added to the terminal, an application programming interface (API) must be generated to map the added application program with the lower MAC layer due to the mapping of the QoS in the terminal. Also, a load applied to the terminal is increased due to the mapping of the QoS in the terminal.

### SUMMARY OF THE INVENTION

An aspect of the present invention is to substantially solve at least the above problems and/or disadvantages and to provide at least the advantages below. Accordingly, an aspect of the present invention is to provide an apparatus and a method for providing a quality of service (QoS) in a wireless communication system.

Another aspect of the present invention is to provide an apparatus and a method for providing a QoS by which a base station (BS) maps the QoS and then transmits the mapped QoS to a terminal so as to minimize a load applied to the terminal in a wireless communication system.

According to one aspect of the present invention, there is provided a method of providing a QoS in a wireless communication system, including: when QoS information of application layers of receiving and transmitting terminals is received, transmitting from an Internet Protocol (IP) Multimedia Subsystem (IMS) server to a policy server an enable media message including the QoS information of the application layers; when the enable media message is received, transforming and mapping the QoS information of the application layer into QoS information of an IP layer in the policy server and transmitting from the policy server to a BS a common open policy service decision (COPS-DEC) message including the QoS information of the IP layer; and when the COPS-DEC message is received, transforming and mapping the QoS information of the IP layer into QoS information of a media access control (MAC) layer in the BS and transmitting from the BS to the transmitting terminal a dynamic service addition request (DSA-REQ) message including the QoS information of the MAC layer.

According to another aspect of the present invention, there is provided an apparatus for providing a QoS in a wireless communication system, including: an IMS server transmitting to a policy server when a call is requested an enable media message including QoS information of application layers of receiving and transmitting terminals connecting the call; the policy server transforming and mapping the QoS information of the application layer into QoS information of an IP layer and transmitting to a BS a COPS-DEC message including the QoS information of the IP layer when the enable media message is received; the BS transforming and mapping the QoS information of the IP layer into QoS information of a MAC layer and transmitting to the transmitting terminal a DSA-REQ message including the QoS information of the MAC layer when the COPS-DEC message is received; and a terminal transmitting a DSA-RSP message to the DSA-REQ message when the DSA-REQ message is received.

According to a further aspect of the present invention, there is provided a method of operating a BS for providing a QoS in a wireless communication system, including when a COPS-DEC message including QoS information of an IP layer is received from a policy server, transforming and mapping the QoS information of the IP layer into QoS information of a MAC layer; and transmitting to a terminal a DSA-REQ message including the transformed and mapped QoS information of the MAC layer.

According still another aspect of the present invention, there is provided a method of operating a terminal for providing a QoS in a wireless communication system, including receiving from a BS a DSA-REQ message including QoS information of a MAC layer; and transmitting to the BS a DSA-RSP message to the DSA-REQ message.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B illustrate a process of generating a Voice over Internet Protocol (VoIP) call in a wireless communication system according to the prior art;

FIG. 2 illustrates a wireless communication system to which the present invention is applied;

FIG. 3 is a block diagram of a wireless communication system according to the present invention;

FIGS. 4A and 4B illustrate a process of generating a VoIP call in a wireless communication system according to the present invention;

FIG. 5 is a flowchart of an operation of a base station (BS) for generating a VoIP call in a wireless communication system according to the present invention; and

FIG. 6 is a flowchart of an operation of a terminal for generating a VoIP call in a wireless communication system according to the present invention.

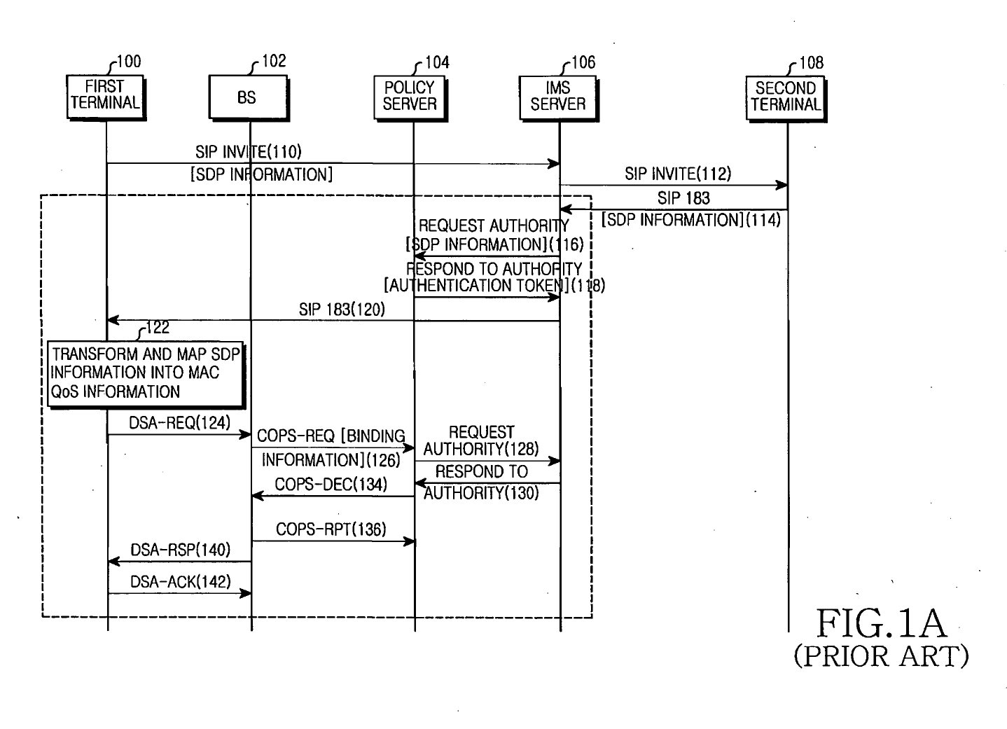

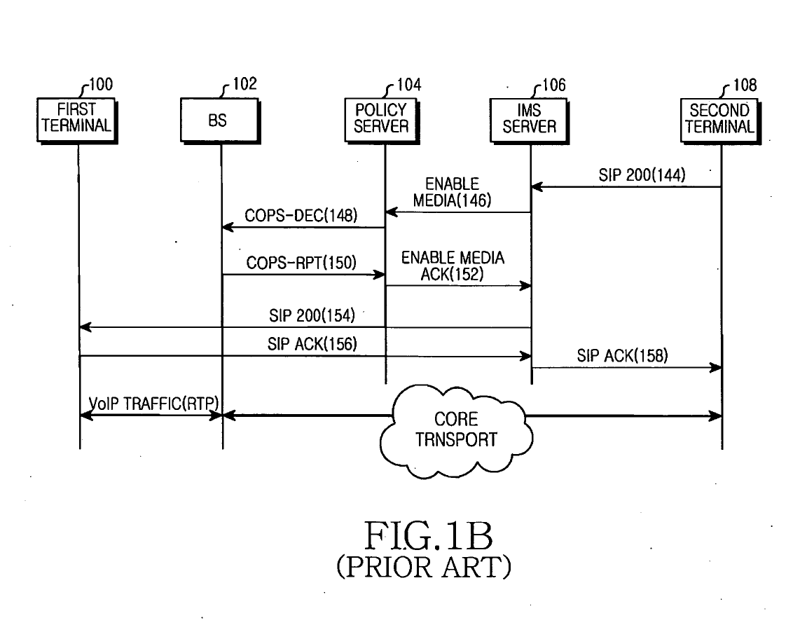

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and a method for providing a quality of service (QoS) by which a base station (BS) maps a QoS of an Internet Protocol (IP) layer into a QoS of a media access control (MAC) layer and then transmits to a terminal the QoS of the MAC layer so as to minimize a load applied to the terminal in a wireless communication system.

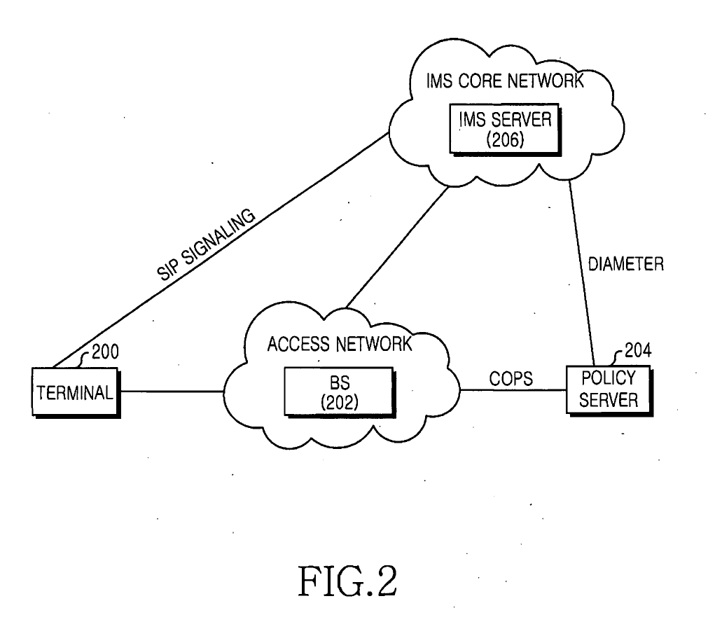

FIG. 2 illustrates a wireless communication system to which the present invention is applied. The wireless communication system includes a terminal 200, a BS 202, a policy server 204, and an Internet Protocol (IP) Multimedia Subsystem (IMS) server 206.

Referring to FIG. 2, the terminal 200 transmits and receives session initiation protocol (SIP) signaling with the IMS server 206 to set a Voice over Internet Protocol (VoIP) call. A SIP refers to a protocol of an application layer capable of setting, changing, and releasing a call of a multimedia video conference or an Internet telephone.

The BS 202 of an access network provides a wireless communication service to a subscriber and manages the session and the mobility of the subscriber. The BS 202 also provides an interface with an IMS core network, obtains QoS policy information through a common open policy service (COPS) interface with the policy server 204, and applies a QoS to each traffic.

The policy server 204 receives a request for a reservation of bearer resources for generating the VoIP call from the IMS core network through a diameter interface, determines the QoS policy information regarding the VoIP call, and transmits the determined QoS policy information to the BS 202 through the COPS interface.

The IMS server 206 of the IMS core network transmits and receives the SIP signaling with the terminal 200 to generate the VoIP call, reports the generation of the VoIP call to the policy server 204 to reserve the bearer resources, and requests enabling of the bearer resources between receiving and transmitting terminals of the policy server 204 to connect a corresponding session.

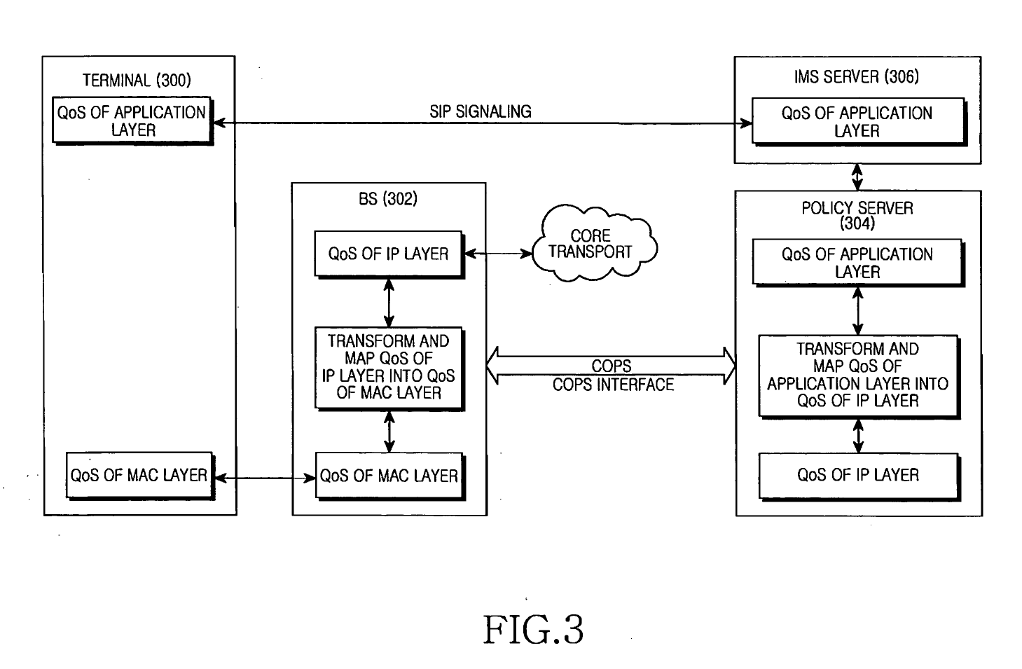

FIG. 3 is a block diagram of a wireless communication system according to the present invention. The wireless communication system includes a terminal 300, a BS 302, a policy server 304, and an IMS server 306.

Referring to FIG. 3, the terminal 300 transmits and receives session description protocol (SDP) information, which indicates QoS information of an application layer, with the IMS server 306 through a SIP signaling and receives QoS information of a MAC layer from the BS 302 to generate a bearer connection to a corresponding session. The SDP information clearly describes information of bearer resources of the corresponding session and includes connection information, media type and format, and a bandwidth. The QoS information of the MAC layer includes a service flow scheduling type, a tolerated jitter, a maximum latency, a maximum sustain traffic rate, a maximum traffic burst, a minimum reserved traffic rate, and a minimum tolerated traffic rate.

The BS 302 receives QoS information of an IP layer from the policy server 304 through a COPS interface, transforms and maps the QoS information of the IP layer into QoS information of the MAC layer, and transmits the transformed and mapped QoS information of the MAC layer to the terminal 300 in order to allocate dynamic resources.

The policy server 304 receives the QoS information of the application layer from the IMS server 306, transforms and maps the QoS information of the application layer into QoS information of an IP layer, and transmits the transformed and mapped QoS information of the IP layer to the BS 302 through the COPS interface. The QoS information of the IP layer includes a source IP address indicating packet classifications, a destination IP address, a protocol, a source port, a destination port, a QoS service class, and a QoS data rate.

When the IMS server 306 receives from the terminal 300 the SIP signaling for starting a session, the IMS server 306 transmits the QoS information of the application layer to the policy server 304 to reserve bearer resources of the corresponding session. When a receiving terminal participates in the corresponding session, the IMS server 306 requests the enabling of the bearer resources of the policy server 204 to connect the corresponding session.

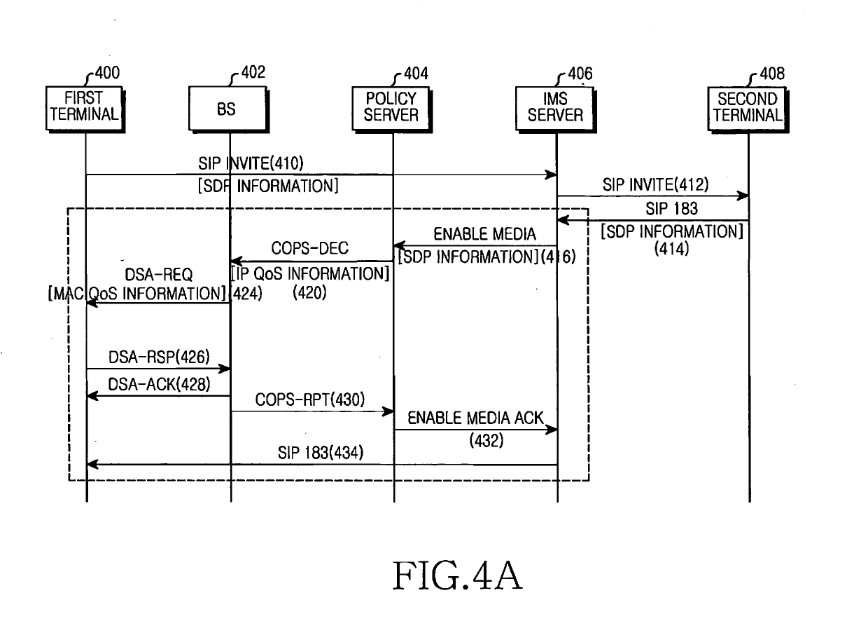

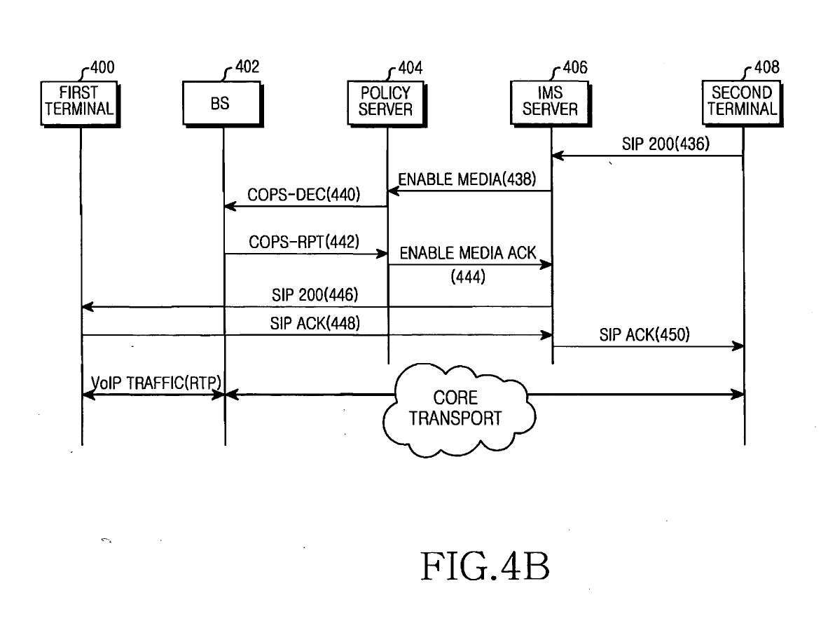

FIGS. 4A and 4B illustrate a process of generating a VoIP call in a wireless communication system according to the present invention.

Referring to FIGS. 4A and 4B, in step 410 a first terminal 400, i.e., a transmitting terminal, transmits to an IMS server 406 an SIP invite message including SDP information as QoS information of an application layer, to generate a VoIP session for a voice call.

In step 412 the IMS server 406 transmits to a second terminal 408 the SIP invite message received from the first terminal 400, i.e., a receiving terminal. In step 414, the second terminal 408 transmits a SIP 183 message including its SDP information to the IMS server 406 to inform the IMS server 406 that a SIP signaling is in progress.

In step 416 the IMS server 406 transmits to the policy server 404 an enable media message including the SDP information of the first and second terminals 400 and 408 to reserve bearer resources of the corresponding VoIP session.

In step 420 the policy server 404 transforms and maps the SDP information of the enable media message into IP QoS information and transmits to the BS 402 a COPS decision (COPS-DEC) message including the transformed and mapped. IP QoS information.

In step 424 the BS 402 transforms and maps the IP QoS information of the COPS-DEC message into MAC QoS information and transmits to the first terminal 400 a dynamic service addition request (DSA-REQ) message including the transformed and mapped MAC QoS information to request a generation of a bearer connection to the corresponding VoIP session.

In step 426 the first terminal 400 transmits to the BS 402 a DSA response (DSA-RSP) message as a response to the DSA-REQ message. Here, the first terminal 100 according to the prior art transforms and maps the SDP information into MAC QoS information and transmits to the BS 102 the transformed and mapped MAC QoS information in order to allocate dynamic resources. However, the first terminal 400 according to the present invention receives the MAC QoS information from the BS 402 through the DSA-REQ message to allocate the dynamic resources. In other words, the first terminal 400 may allocate the dynamic resources without performing a process of transforming and mapping a QoS.

In step 428 the BS 402 transmits to the first terminal 400 a DSA acknowledge (DSA-ACK) message as a response message to the DSA-RSP message to generate a bearer connection to the corresponding VoIP session. In step 430 the BS 402 transmits to the policy server 400 a COPS report (COPS-RPT) message as a response message to the COPS-DEC message.

In step 432 the policy server 404 transmits to the IMS server 406 an enable media ACK message to the enable media message. In step 434 the IMS server 406 transmits to the first terminal 400 the SIP 183 message received from the second terminal 408.

When a user of the second terminal 408 accepts a voice call requested from the first terminal 400, in step 436 the second terminal 408 transmits to the IMS server 406 a SIP 200 message as a response message indicating a participation in the corresponding VoIP session. In step 438 the IMS server 406 transmits to the policy server 404 an enable media message to enable the allocated bearer resources. In step 440 the policy server 404 transmits to the BS 402 the COPS-DEC message to request enabling of the allocated bearer resources.

The BS 402 enables the allocated bearer resources so that the transmitting and receiving terminals perform a data communication with each other. In step 442 the BS 402 transmits to the policy server 404 the COPS-RPT message as the response message to the COPS-DEC message. In step 444 the policy server 404 transmits to the IMS server 406 the enable media ACK message to the enable media message.

In step 446 the IMS server 406 transmits to the first terminal 400 the SIP 200 message received from the second terminal 408. In step 448 the first terminal 400 transmits to the IMS server 406 a SIP ACK message about the receipt of the SIP 200 message. In step 450 the IMS server 406 transmits to the second terminal 408 the SIP ACK message to end the process of generating the VoIP call.

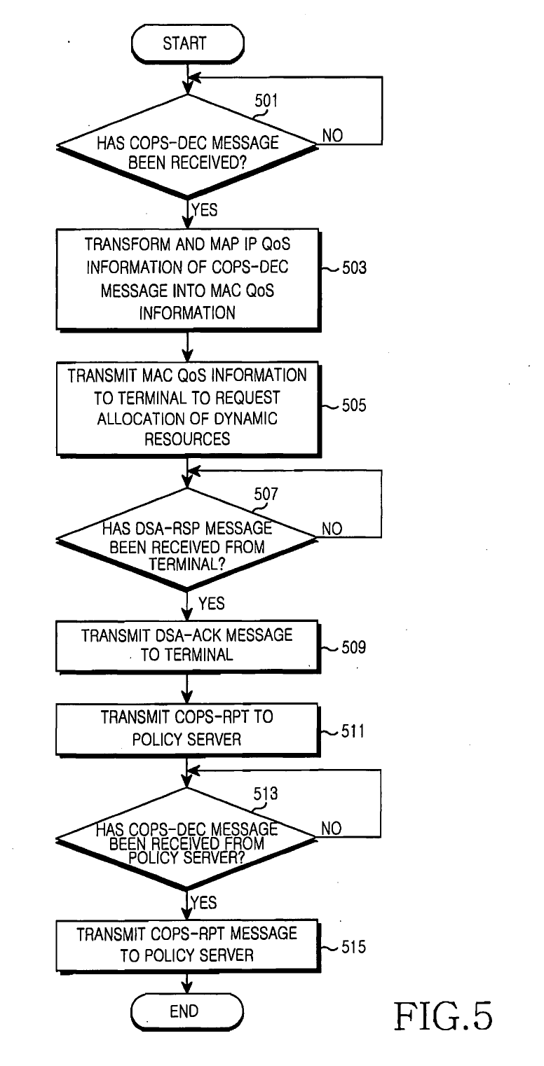

FIG. 5 is a flowchart of an operation of a BS for generating a VoIP call in a wireless communication system according to the present invention.

Referring to FIG. 5, in step 501, the BS 402 determines whether a COPS-DEC message including IP QoS information has been received from the policy server 404. If it is determined that the COPS-DEC message has been received from the policy server 404, the BS 402 goes to step 503 to transform and map the IP QoS information into MAC QoS information. In step 505 the BS 402 transmits a DSA-REQ message including the transformed and mapped MAC QoS information to the first terminal 400 to generate a bearer connection to a corresponding session.

In step 507, the BS 402 determines whether a DSA-RSP message as a response message to the DSA-REQ message has been received from the first terminal 400. If it is determined that the DSA-RSP message has been received from the first terminal 400, the BS 402 proceeds to step 509 to transmit a DSA-ACK message to the first terminal 400 and allocate bearer resources of the corresponding session so as to generate the bearer connection. In step 511 the BS 402 transmits a COPS-RPT message as a response message to the COPS-DEC to the policy server 404.

In step 513, the BS 402 determines whether the COPS-DEC message for enabling the allocated bearer resources has been received from the policy server 404. If it is determined that the COPS-DEC message has been received from the policy server 404, the BS 402 links an access network to an IMS core network to allow the first and second terminals 400 and 408 to perform a data communication through the generated bearer connection and then in step 515 transmits the COPS-RPT message to the policy server 404. The BS 402 ends the algorithm of the present invention.

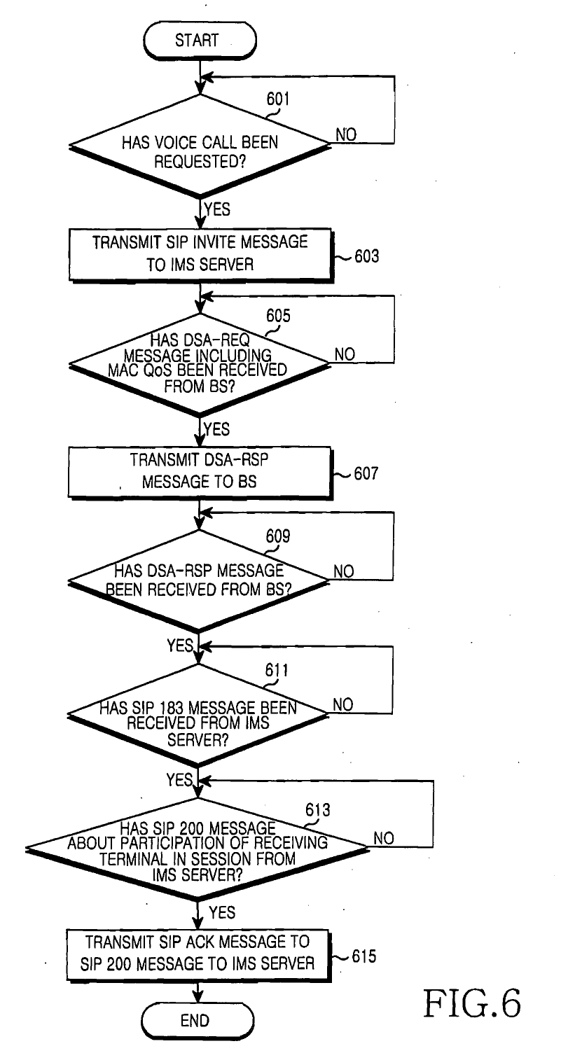

FIG. 6 is a flowchart of an operation of a terminal for generating a VoIP call in a wireless communication system according to the present invention.

Referring to FIG. 6, in step 601, the first terminal 400 determines whether a user has requested a voice call. If it is determined that the user has requested the voice call, the first terminal 400 proceeds to step 603 to transmit a SIP invite message including SDP information to the IMS server 406 in order to generate a VoIP session for the voice call.

In step 605, the first terminal 400 determines whether a DSA-REQ message including MAC QoS information to request a generation of a bearer connection has been received from the BS 402. If it is determined in step 605 that the DSA-REQ message has been received from the BS 402, in step 607 the first terminal 400 transmits a DSA-RSP message as a response message to the DSA-REQ message to the BS 402. The first terminal 400 goes to step 609 to determine whether a DSA-ACK message has been received from the BS 402.

If it is determined that the DSA-ACK message has been received from the BS 402, in step 611 the first terminal 400 determines whether a SIP 183 message has been received from the IMS server 406. If it -is determined in step 611 that the SIP 183 message has been received from the IMS server 406, the first terminal 400 proceeds to step 613 to determine whether a SIP 200 message about a participation of the second terminal 408 in a session has been received from the IMS server 406. If it is determined in step 613 that the SIP 200 message has been received from the IMS server 406, in step 615 the first terminal 400 transmits a SIP ACK message as an acknowledge message to the SIP 200 message to the IMS server 406.

The first terminal 400 ends the algorithm of the present invention.

In accordance with the present invention as described above, a BS can transmit QoS information of a MAC layer to a terminal to provide a QoS in a wireless communication system. Thus, the terminal does not need to perform a process of transforming and mapping the QoS. As a result, a load applied to the terminal can be reduced. In particular, QoS information of an application layer is independent of QoS information of the MAC layer in the terminal. Thus, an application programming interface (API) for transforming and mapping the QoS does not need to be generated. Also, a QoS flexible to various applications can be applied due to the separation between the application layer and the MAC layer.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of providing a quality of service (QoS) in a wireless communication system, comprising:
when QoS information of application layers of receiving and transmitting terminals is received, transmitting from an Internet Protocol (IP) Multimedia Subsystem (IMS) server to a policy server an enable media message that includes the QoS information of the application layers;
when the enable media message is received, transforming and mapping the QoS information of the application layer into QoS information of an IP layer in the policy server and transmitting from the policy server to a base station (BS) a common open policy service decision (COPS-DEC) message that includes the QoS information of the IP layer; and
when the COPS-DEC message is received, transforming and mapping the QoS information of the IP layer into QoS information of a media access control (MAC) layer in the BS and transmitting from the BS to the transmitter terminal a dynamic service addition request (DSA-REQ) message that includes the QoS information of the MAC layer.

2. The method of claim 1, further comprising:
when the DSA-REQ message is received, transmitting from the transmitting terminal to the BS a DSA response (DSA-RSP) message to the DSA-REQ message;
transmitting from the BS to the transmitting terminal a DSA acknowledge (DSA-ACK) message to allocate bearer resources and transmitting from the BS to the policy server a COPS report (COPS-RPT) message to the COPS-DEC message;
when the COPS-RPT message is received, transmitting from the policy server to the IMS server an enable media acknowledge,(ACK) message to the enable media message; and
when the enable media ACK message to the enable media message is received, transmitting from the IMS server to the transmitting terminal a session initial protocol (SIP) 183 message that a SIP signaling is in progress.

3. The method of claim 1, further comprising:
when a SIP message that includes the QoS information of the application layer is received from the transmitting terminal, transmitting from the IMS server to the receiving terminal the SIP message; and
when the SIP message is received, transmitting from the receiving terminal to the IMS server a SIP message comprising the QoS information of the application layer.

4. An apparatus for providing a QoS in a wireless communication system, comprising:
an IMS server transmitting to a policy server an enable media message that includes QoS information of application layers of receiving and transmitting terminals connecting a call when a call is requested;
the policy server transforming and mapping the QoS information of the application layer into QoS information of an IP layer, and transmitting to a BS a COPS-DEC message that includes the QoS information of the IP layer when the enable media message is received;
the BS transforming and mapping the QoS information of the IP layer into QoS information of a MAC layer, and transmitting to the transmitting terminal a DSA-REQ message that includes the QoS information of the MAC layer when the COPS-DEC message is received; and
a terminal transmitting a DSA-RSP message in response to the DSA-REQ message when the DSA-REQ message is received.

5. The apparatus of claim 4, wherein when the DSA-RSP message to the DSA-REQ message is received from the terminal, the BS transmits a DSA-ACK message in response to the DSA-RSP message to allocate bearer resources.

6. A method of operating a BS for providing a QoS in a wireless communication system, comprising:
when a COPS-DEC message that includes QoS information of an IP layer is received from a policy server, transforming and mapping the QoS information of the IP layer into QoS information of a MAC layer; and
transmitting to a terminal a DSA-REQ message that includes the transformed and mapped QoS information of-the MAC layer.

7. The method of claim 6, further comprising when a DSA-RSP message is received from the terminal, transmitting to the terminal a DSA-ACK message to allocate bearer resources.

8. The method of claim 7, further comprising when the DSA-RSP message is received from the terminal, transmitting to the policy server a COPS-RPT message.

9. A method of operating a terminal for providing a QoS in a wireless communication system, comprising:
receiving a DSA-REQ message that includes QoS information of a MAC layer from a BS; and
transmitting to the BS a DSA-RSP message in response to the DSA-REQ message.
